(19) United States
(12) Patent Application Publication
(10) Pub. No.: US 2025/0307019 A1
(43) Pub. Date: Oct. 2, 2025

(54) DISTRIBUTED SENSOR TRACKING ACCELERATION FOR DATA CENTER MANAGEMENT

(71) Applicant: Hewlett Packard Enterprise Development LP, Spring, TX (US)

(72) Inventors: Sai Rahul Chalamalasetti, Milpitas, CA (US); Philipp Raith, Milpitas, CA (US); Gourav Rattihalli, Milpitas, CA (US); Dejan S. Milojicic, Milpitas, CA (US); Naysen J. Robertson, Roseville, CA (US)

(21) Appl. No.: 18/623,970

(22) Filed: Apr. 1, 2024

(51) Int. Cl. G06F 9/50; G06F 9/48

(52) U.S. Cl. CPC G06F 9/505; G06F 9/4881

(57) ABSTRACT

In one example implementation, a computer-implemented method includes sending instructions from a scheduler directly to a plurality of compute resources to obtain sensor data from the plurality of compute resources. The sensor data is received directly from the compute resources. The scheduler develops a workload distribution plan based on information related to applications waiting to be executed and the sensor data received from the compute resources. The applications are assigned to the compute resources according to the workload distribution plan.

### BACKGROUND

A cloud-based data center is an advanced computing environment that leverages a network of remote servers hosted on the internet to store, manage, and process data, rather than relying on local servers or personal computers. At the heart of this data center is the scheduler, a system that orchestrates the distribution and execution of workloads across the available compute and storage nodes. The scheduler ensures that resources are allocated efficiently, balancing the demands of various applications and services to optimize performance and minimize latency.

Integral to the data center's operations is the baseboard management controller (BMC), a specialized microcontroller embedded within each server that operates independently of the main system. The BMC provides out-of-band management, enabling remote monitoring, management, and recovery of servers, even in the event of system failures or when the operating system is not running. It continuously gathers data from an array of sensors monitoring temperature, power, and other system parameters, and can execute management actions such as system resets or fan speed adjustments. This real-time data is communicated back to the scheduler via a system monitor. The scheduler uses the data to make informed decisions about resource management to enable the data center to run efficiently and reliably.

### BRIEF DESCRIPTION OF THE DRAWINGS

Aspects of the present disclosure are best understood from the following detailed description when read with the accompanying figures.

FIG. 1 depicts a computer system with a scheduler communicating with various components, according to example implementations.

FIG. 2 depicts a computing system according to example implementations.

FIG. 3A depicts a system that includes a BMC and a hardware accelerator, according to example implementations.

FIG. 3B depicts another system that includes a BMC and a hardware accelerator, according to example implementations.

FIG. 4 depicts a flowchart for a data center management system according to example implementations.

FIG. 5 depicts a flowchart for BMC processing according to example implementations.

FIG. 6 depicts a flowchart of a software-based scheduler flow for data center management according to example implementations.

FIG. 7 depicts a flow chart for an implementation example of a scheduler.

FIG. 8 depicts a flow chart for another implementation example of a scheduler.

FIG. 9 depicts a flow chart for an implementation example for a BMC.

Corresponding numerals and symbols in the different figures generally refer to corresponding parts unless otherwise indicated. The figures are drawn to clearly illustrate the relevant aspects of the disclosure and are not necessarily drawn to scale.

### DETAILED DESCRIPTION

The following disclosure provides many different examples for implementing different features. Specific examples of components and arrangements are described below to simplify the present disclosure. These are, of course, merely examples and are not intended to be limiting.

As data centers expand to accommodate larger workloads, their power consumption has surged to nearly 20% of global energy usage, prompting a search for optimization strategies to enhance efficiency. A notable challenge in current data center management is the reliance on centralized sensor information tracking, which is pivotal for real-time application scheduling and fault detection. This centralized approach, typically managed by a baseboard management controller (BMC), is designed for coarse-grained tracking and struggles to scale with the dynamic demands of as-a-Service (aaS) models. The legacy BMC interfaces, such as i2C/SPI, are robust yet hindered by slow transfer speeds and lengthy read request loops, leading to a bottleneck in closing the acquisition-response loop between sensor data collection and action/execution. Consequently, the existing sensor tracking infrastructure, with its centralized data aggregation and action-taking capabilities, fails to keep pace with the rapid execution spans of aaS applications, resulting in suboptimal scheduling and quality of service (QoS).

To address these inefficiencies, the disclosed technology introduces a hardware and software optimization framework that leverages distributed sensors for intelligent, real-time data center management. The solution encompasses a high-speed, centralized/distributed data path interfaced with the BMC via an accelerator. Traditionally, the BMC interfaces to sensors on a server node to support coarse-grained sensor tracking which is limited to slower transfer speeds and long read request loops. In addition, the sensor tracking infrastructure is limited to a centralized collection node that aggregates the data from various servers and schedules an action based on the data in a serialized manner.

To optimize the sensor tracking infrastructure, an accelerated and distributed sensor infrastructure may be integrated into a scheduler to form a tightly-coupled hybrid unit that controls low-level components and high-level components. The scheduler may be configured to control and submit jobs to the compute/storage nodes and may communicate with the server BMCs, top of the rack (TOR) switches, top of the rack power control units, and inter-rack cooling apparatuses. The scheduler may follow a defined protocol for BMC communication for online/runtime fine-grained scheduling. For example, the scheduler can have access to accelerator executables that it can share with the protocol for the fine-grained scheduling.

The inclusion of the accelerator allows for the elimination of the system monitor (e.g., Prometheus™) and allows for finer grained control of the system. This mechanism provides a benefit over conventional methods where the scheduler requests sensor data from the system monitor, which in turn requests the data from the BMC. Inclusion of the accelerator allows the scheduler to obtain the sensor data more quickly allowing for finer control of task management. As another advantage, the BMC can utilize the sensor data and take action based on the results in real time. As an example, more tightly controlled server-localized temperature responses can be obtained.

The accelerator function can be implemented in a number of ways. In one implementation, the additional functionality is integrated into the BMC. In another implementation, a separate chip, e.g., a field programmable gate array (FPGA), a complex programmable logic device (CPLD), or an application-specific integrated circuit (ASIC), is included in the path between the BMC and the device sensors. When new hardware is not available, the finer-grained tracking can be implemented by changing the software to allow the scheduler to obtain the sensor data directly.

The additional low-level communication path can circumvent board-level constraints and facilitate rapid sensor data collection. This innovative communication setup between the scheduler/sensor tracking aggregator and the BMC enables efficient processing of sensor data in proximity to the BMC. Recognizing the limitations of BMC's built-in ALUs for handling complex, long-timescale computations, the technology incorporates an additional accelerator data path within the configurable setup. By integrating this accelerated and distributed sensor infrastructure into the runtime data center management system, a tightly-coupled hybrid unit is formed, capable of intelligently controlling both low-level hardware components, such as power supply units, and high-level software components, like applications.

There are a number of advantages of this distributed sensor tracking system. By using asynchronous communications to adopt a fire-and-forget communication model, the BMC can collect data at the start and end of applications, directly sending events to the scheduler, thereby enhancing scalability and insight into system performance without the traditional bottlenecks. Intelligent BMCs, empowered with action delegation, can autonomously monitor and execute actions, reducing the latency associated with decision-making processes. The system's ability to perform fine-grained actions based on real-time events, such as power consumption and carbon emission intensities, represents a novel approach that was previously unattainable. Furthermore, the distributed nature of the sensors facilitates new management strategies that consider the interrelationships between different data center components, leading to more efficient resource allocation and system responsiveness. By enabling delegated actions at both the hardware and software levels, the technology reduces the overhead of autonomous cluster management and allows for a more granular implementation of events and actions, surpassing the capabilities of current systems.

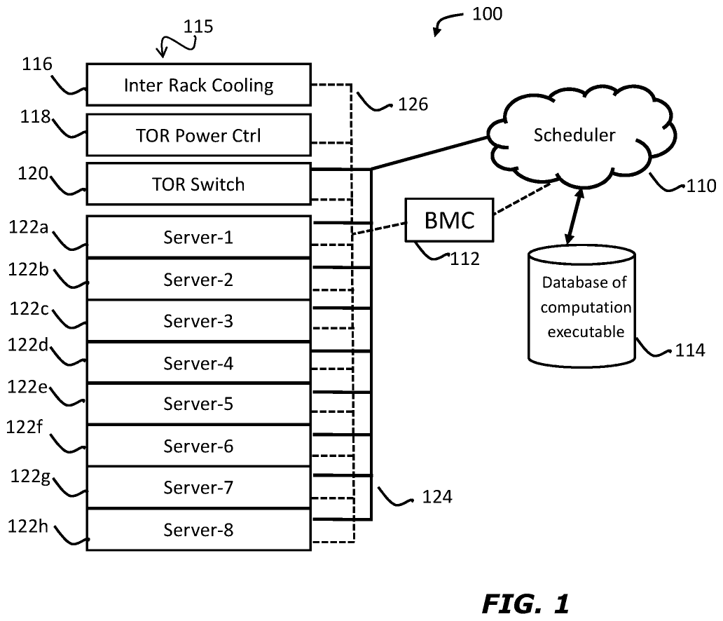

FIG. 1 provides a block diagram of a computer system 100, e.g., a rack or cluster. As an example, the computer system 100 can be used, perhaps in combination with other such computer systems, to implement a cloud service. In some aspects, the computer system 100 includes a scheduler 110 that is connected to a baseboard management controller (BMC) system 112. The scheduler 110 and the BMC system 112 control the operation of compute resources 115, which are illustrated as an inter-rack cooling unit 116, a top of the rack power control unit 118, a top of the rack (TOR) switch 120, and a plurality of servers 122a-122h. The servers 122a-122h shown in FIG. 1 are merely an example illustration. The plurality of servers 122 can include any number of multiple servers. The compute resources 115 illustrated in FIG. 1 are provided only for the purpose of illustration and can include any portion of the computer system including compute nodes and storage nodes.

The scheduler 110 may be configured to control and submit jobs to the compute resources 115 via communication path 124. As but one example, the scheduler can send Linux commands to the various CPUs over an Ethernet connection. At the same time, the scheduler 110 may communicate with the BMC 112 to control low level operations of the compute resources 115. In example implementations, the scheduler 110 may follow a defined protocol for BMC communication for online/runtime fine-grained scheduling. In some cases, the scheduler 110 is linked to database 114, which stores executable programs.

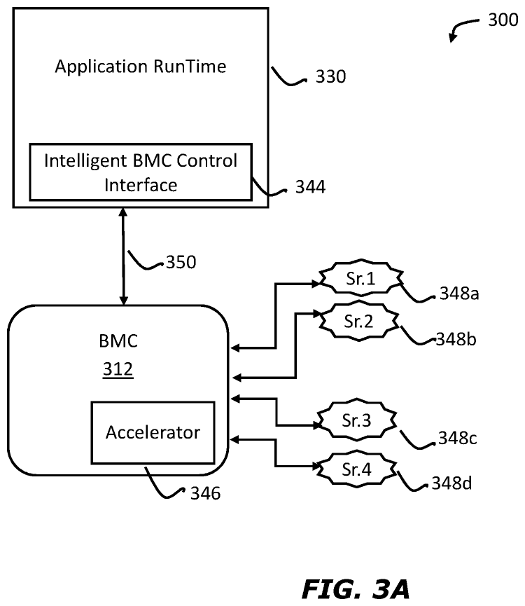

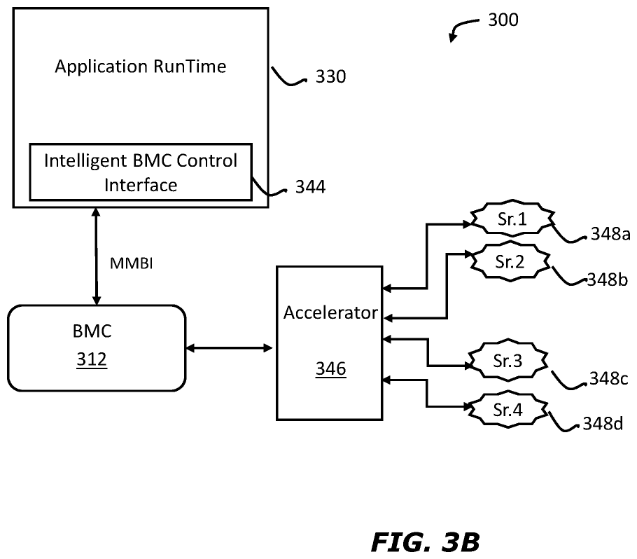

While illustrated as a single block, it is understood that the BMC system 112 is typically implemented using a number of devices (e.g., chips), each of which is associated with each compute resource 115. In other words, the BMC 112 function is distributed among a number of BMC components. For simplicity, the term “BMC” will be used herein to describe any device or group of devices that perform BMC functions as disclosed herein or otherwise known in the art. For example, the BMC 112 can be implemented with specialized microcontrollers, each embedded on the motherboard of the associated compute resource 115. Each individual BMC controller is configured to monitor sensors (e.g., 348 in FIG. 3) within its associated compute resource 115. The sensors can measure parameters such as temperature, cooling fan speeds, power status, operating system status, server system state, error status, etc. While monitoring the sensors, the BMC 112 may send alerts to a system administrator when parameters of the monitored sensors indicate potential failure in the system.

The scheduler 110 interacts with the BMC 112 to gain insights into the real-time status of the hardware and to make informed decisions about resource allocation. This interaction typically involves a number of steps. First, the scheduler 110 sends requests to the BMC 112 to retrieve sensor data or to execute specific management actions on the server. The BMC 112 collects data from various sensors on the server, such as temperature, power consumption, and fan speeds, and reports this data back to the scheduler 110. Based on the sensor data and the current workload requirements, the scheduler 110 may instruct the BMC 112 to perform actions such as adjusting fan speeds, power capping, or initiating a server reboot. The BMC 112 executes the actions as instructed by the scheduler 110 and provides confirmation or status updates back to the scheduler 110. As discussed below, the intelligent BMC 112 can execute some of these operations without direct instruction from the scheduler 110 using predetermined, adjustable sensor action-table profiles or configurations.

This interaction enables the scheduler 110 to maintain an optimized environment for running applications by dynamically adjusting the compute resources 115 based on real-time data provided by the BMC 112. The configuration shown in FIG. 1 illustrates the centralized control and communication between the scheduler 110 and the various components of the data center, facilitated by the BMC block 112, to manage tasks such as job submission, cooling, power control, and packet scheduling.

The BMC 112 directly interfaces with components of the compute resources 115 via communication path 126 to perform its management and monitoring functions. The communication path 126 provides a custom data path that allows the BMC 112 to process data quickly. In this interaction the BMC 112 uses dedicated communication interfaces, such as MMBI (Memory Mapped BMC interface), to monitor the status of compute resources 115, including CPUs, memory, storage, and network interfaces. As is known, MMBI is a protocol promulgated by Distributed Management Task Force (DMTF). Other protocols, such as PCIE (Peripheral Component Interconnect Express) or 13C as examples, could alternatively be used.

The system 100 has the capability to control different components in the datacenter. For example, for compute nodes 115, functions such as fan speed and CPU frequency can be controlled. Packet scheduling for Ethernet across ports can be controlled through the TOR switch 120. Inter-rack cooling unit 116 can decrease cooling for nodes that are not that busy or when an energy source is not clean. For these operations, the BMC 112 functions as an intelligent real-time aggregator for fine-grained scheduling as directed by the scheduler 110.

The interactions between the scheduler 110, BMC 112, and compute resources 115 are programmable. For example, the scheduler 110 can instruct the BMC 112 to pull sensor data at a given frequency to provide one level of optimization. At another level of optimization the scheduler can instruct the BMC 112 to take a particular action if a certain condition is sensed. For example, the BMC can be instructed to increase a fan speed if a particular heat sensor from a server or from a CPU is crossing a high watermark threshold. By having the BMC 112 take autonomous action rather than wait for a specific instruction from the scheduler 110, control is moved closer to the server and, as a result, the action-response latency is improved.

In addition to the hardware modifications, there is a software component where scheduler 110 schedules applications onto the servers 122. By having sensor data automatically being retrieved, the system can be proactive so that a request from scheduler 110 will include a request to the BMC 112, which will have this intelligence to take an action. In conventional systems, a scheduler takes action based on previous data, which will be less accurate due to the latency required in instructing a system monitor to request the BMC to obtain the sensor data and then return the information through the system monitor. The fire-and-forget setup of the present communication scheme provides an asynchronous mechanism to reduce latency.

The scheduler 110 can also use the sensor data to more accurately predict which resources should be utilized for upcoming jobs. At any given time, the scheduler 110 may have a stack of different applications that it needs to execute or jobs it needs to run. Having more accurate information regarding the conditions of the compute resources 115, the scheduler 110 can better optimize scheduling by predicting future thermal loads and power availability. For example, the scheduler 110 may have the ability to know the type of job, e.g., whether it's CPU-centric, memory-centric, focused on input/output, or a blend thereof. Using this knowledge and the telemetry gathered from the various BMCs and servers, the scheduler 110 can implement fine-grained decision making. This knowledge can be used in other schedulers as well.

In other words, the distributed sensors enable new management strategies based on relationships across different components. For example, in a typical data center rack with multiple server blades installed, a distributed intelligent sensor approach enables emitting events based on fine-grained monitoring of data within the rack. Delegated actions can be split into low/hardware-level and high/software-level actions. High level actions act on application level (e.g., containers) while low-level ones manipulate hardware components (e.g., CPU, PSU). High-level local vertical autoscaling increases/decreases resources of running applications while horizontal autoscaling creates/removes new application instances, and application reconfiguration enables lightweight application-specific runtime parameter optimization. In contrast to current autoscaling approaches (e.g., Kubernetes), local autoscaling can happen at a much higher frequency and can be based on fine-grained monitoring data.

Low-level local autoscaling approaches can perform actions such as cooling tuning (e.g., fan speed), power capping (CPU, GPU, etc.), throttling (e.g., network, CPU), dynamic frequency scaling, and fine-grained resource allocation and deallocation. This autoscaling happens autonomously and transparently to the remaining system and offers a higher responsivity than current approaches. Events for delegated actions can aggregate local fine-grained data concerning resource usage, resource contention, heat development, and others.

To illustrate these points, an example can be considered with heat development and network traffic between blades. Actions can include the configuration of power levels (e.g., when the sensor detects that GPU are underutilized it can tweak the max power consumption) or network-level related actions can be taken. For example, actions can include the reallocation of bandwidths between servers depending on the applications.

Delegated actions reduce the overhead of autonomous management of the cluster (i.e., network traffic) and its management components (i.e., scheduler and autoscaler). Moreover, events and actions can be implemented in such a fine-grained manner that is with current systems not feasible due to system implicit overheads.

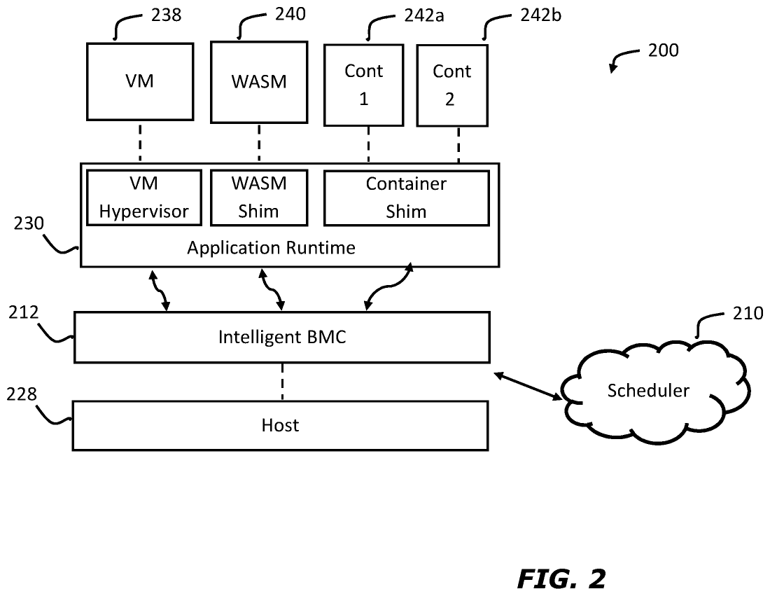

FIG. 2 illustrates a block diagram of a computing system 200, which provides an example software used to implement system 100. The illustrated system 200 includes a scheduler 210 that communicates with a compute resource, e.g., a server that includes intelligent BMC 212 and host 228. The scheduler 210 may be configured to control and submit jobs to the host 228 of the compute/storage node and also communicate with the BMC 212 as described above.

This figure illustrates the application of the intelligent BMC 212 in the application runtime layer. The host 228 along with the BMC 212 communicate with the application runtime layer 230. Applications in data centers are executed in application runtimes 230 that offer isolation between processes and can use virtualization techniques. Examples of commonly used application runtimes 230 can include a virtual machine (VM) hypervisor, a WebAssembly Module (WASM) shim, and a container shim. It is understood that these particular examples are illustrative only.

The shim can implemented as a software layer that acts as an intermediary between higher-level components (such as the scheduler 210) and lower-level infrastructure (such as components of the compute resources). This layer provides an abstraction that enables the scheduler 210 to interact with different types of compute resources 115, without needing to be tailored to the specifics of each underlying environment or resource type. When the scheduler needs to allocate resources for a task or workload, it sends an instruction to the shim. The shim, understanding the capabilities and current state of the underlying compute resource 115, then interprets and executes the necessary commands.

In the illustrated example, these runtimes are associated with virtual machine 238, WebAssembly 240, and containers 242a and 242b, respectively. Again, the examples are provided only to illustrate virtualization techniques that can be implemented here. The application runtimes 230 can start and stop applications and dynamically configure the resources available to the applications. For example, runtimes can set the number of CPU cores available and enable security and isolation between processes. The BMC 212 can communicate directly with the application runtime layer 230 to allow the fine-grained actions discussed herein. Examples of actions that can be taken include an increase (or decrease) of the CPU frequency, duty cycle modulation (DCM) of a power pedal, or throttle (increase or decrease) the network bandwidth of the containers 242.

By interfacing the intelligent BMC 212 with the application runtime, e.g., through an MMBI, the BMC 212 can be extended to work with any application deployment in data centers. The intelligent BMC 212 and application scheduler 210 interact with each other to autonomously manage the system, e.g., in an energy- and carbon-aware manner. The fine-grained monitoring capabilities discussed herein can offer insight into energy consumption while the scheduler 210 can take actions and plan according to carbon emission intensities and datacenter policy limits.

FIGS. 3A and 3B illustrate the hardware to implement the intelligent functionality of the BMC 312 described herein. The system 300, which might represent one of the compute resources 115 in FIG. 1, allows the application runtime 330 to interface with BMC 312 through, for example, an MMBI 344. The BMC integrated data paths 350 can be used for computation, e.g., by accelerator 346.

FIG. 3A provides a block diagram of a first implementation of the system 300. As noted above, application runtime 330 interfaces with BMC 312 through intelligent BMC control interface 344 and datapath 350. In the example of FIG. 3A, a hardware accelerator 346 is integrated with circuitry of the BMC 346. FIG. 3B illustrates a similar system but with the accelerator 346 implemented in a separate chip. In other embodiments, the functionality can be distributed between these two chips perhaps with other chips as well.

The hardware accelerator 346 may be configured to process data from the sensors 348a-348d. While four sensors are shown, it is understood that fewer or more sensors can be included with each compute resource. In some cases, the hardware accelerator 346 may be a reconfigurable accelerator, such as an FPGA (field programmable gate array), PLD (programmable logic device), or ASIC (application specific integrated circuit) that is set up to have reconfigurable connectivity to the local sensors 348a-348d. Configurability, while not a requirement, is an advantage due to ever changing computation requirements.

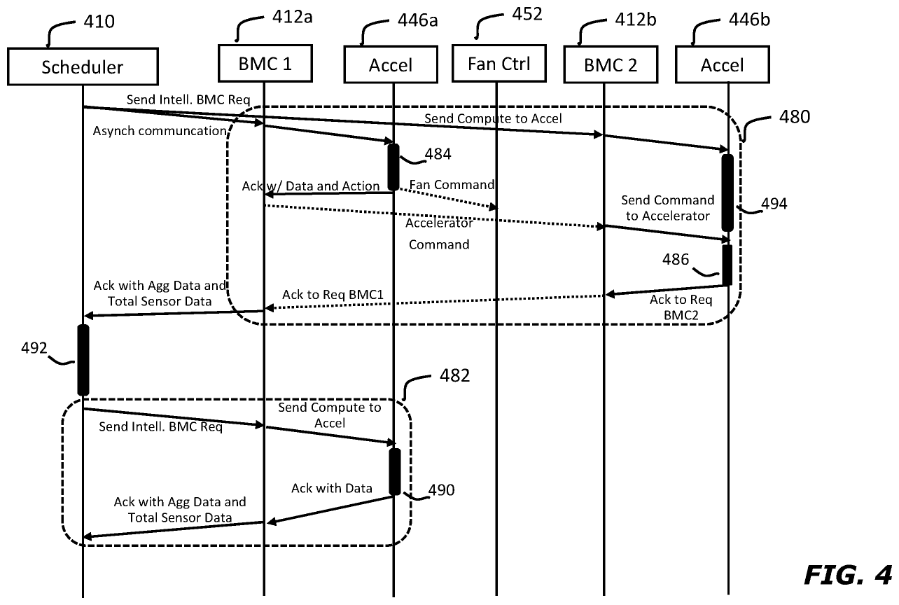

FIG. 4 depicts a flowchart of a data center management system. Two flows are shown in the figure. The top portion 480 shows BMC control of intra-node sensor and inter-node sensor and real-time optimized scheduling (vertical scaling), e.g., for fan control. The bottom portion 482 shows the BMC aggregation and grouping of data for the scheduler to use for offline-processing (fine-grained data collection). It is noted that these flows do not require a system monitor such as Prometheus™, although one can still be used for long term storage.

FIG. 4 shows the interaction between a scheduler 410 along with two BMCs 412a and 412b and associated accelerators 446a and 446b. Fan controller 452 is included as an example of a component to be controlled. While a fan controller is provided as an example, it is understood that any of the components of the compute resources 115 can be substituted with a similar result.

Referring first to the flow 480, the scheduler 410 sends intelligent BMC requests to first BMC 412a and second BMC 412b. The request to BMC 412a is an asynchronous communication request to obtain sensor information. The BMC 412a utilizes the accelerator 446a to obtain sensor data from the sensors of the compute resource. For example, the request may be for temperature sensor tracking. The collected sensor data is collected as indicated by function 484 and then returned to the BMC 412a. The asynchronous communication request can be thought of as a “fire-and-forget” command in the sense that instead of individually sending the sensor read commands one after another (serially), the accelerator 446a can be programmed to perform these reads (or even respond with writes locally based on certain criteria) autonomously and after some duration of operation or other criteria such execution/buffer-size limit, the scheduler 410 can be “interrupted” to read out status or completion state or a list of rendered sensor information.

This data can facilitate real-time optimized scheduling. As the data is collected, it is written back to the scheduler 410. When there is an interdependency between servers, e.g., one server is faster because it is not as hot and can therefore execute faster than the second server, the scheduler can use this information in assigning jobs to the servers. Here because the data from the two BMCs has been collected with the same start and stop times, it is easier for the scheduler 410 to utilize the optimal resources. As such, the aggregation of data is useful for the scheduler for optimizing future scheduling operations.

In addition to collecting sensor data from its associated node, the BMC 412a can send an accelerator command to BMC 412b, which in turn utilizes accelerator 446b to collect sensor data from its associated node. The data collected by BMC 412b can be returned to BMC 412a, which aggregates the data and sends total sensor data to the scheduler 410.

The communication flow 480 also illustrates how the BMCs 412 can independently take action based on the collected sensor data. For example, BMC 412a could collect temperature information and, based on this information, control the fan 452 via a fan command. For example, if the temperature is above a high threshold, the fan controller 452 can be instructed to increase a fan speed. More fine-tuned moving average or area-under-the-curve time-series based thresholds can be calculated at the local accelerator near the point of measurement. The BMC 412a could acknowledge the completion of this fan control task with an acknowledge signal (ACK). Similarly, the BMC 412b can be instructed to check the CPU frequency and fan speed and, based on the finding, decrease the fan speed or the clock frequency. Of course, these are but two examples provided to illustrate tasks that can be performed. Many other actions can be taken by the BMCs.

The communications can utilize a fire-and-forget approach with asynchronous requests. The following provides an example representation of how the API/communication interface can be updated to support communication discussed herein. One goal is to avoid having the scheduler 410 continuously poll to check the status of the request. Rather, the BMC 412 can acknowledge the request after full data collection for time duration/application execution to avoid using scheduler resource and bandwidth thereby enabling the scheduler to perform other tasks.

To request information sent to the BMC, the request can include information as shown in Table 1.

TABLE 1

| | |
|---|---|
| Nodes to track and control | {local node, remote nodes} |
| Sensor to track | {sensor_fan1, sensor_tempxy, . . . |
| | sensor_pwrunit |
| Remote node sensor track | {e.g., node2_sensor_fan2} |
| Time duration for collection | {e.g., 10 ms} |
| Wait on app start/end from node | {yes/no} |
| Computation | {ML inference, Aggregation, etc.} |
| Computation executable | {for datapath, e.g., bit stream |
| | for FPGA} |
| Local Action to be taken | {control_fan1speed} |
| Remote Action to be taken | {Node2_control_cpu_freq} |

The response from the BMC to the scheduler can include information and a summary of actions taken as shown in Table 2.

TABLE 2

| | |
|---|---|
| Sensor data stream for time duration | {e.g., 50%, 100% . . . } |
| requested or App duration | |
| Computed data from the sensor | {e.g., average fan speed: 70%} |
| Actions taken | {e.g., controlled_fan1_speed, |
| | controlled_node2_fan_speed} |

The bottom flow 482 is provided to show an example of fine-grained data collection. In this example, scheduler 410 sends an intelligent BMC request to BMC 412a. The BMC 412a in turn sends a compute command to the accelerator 446a, which collects sensor data for the indicated time period, e.g., between a start time and stop time provided by the scheduler 410. The accelerator 446a acknowledges the request and returns the data to the BMC 412a, which can then provide the data to the scheduler, either in real time or aggregated into a single communication or multiple communications.

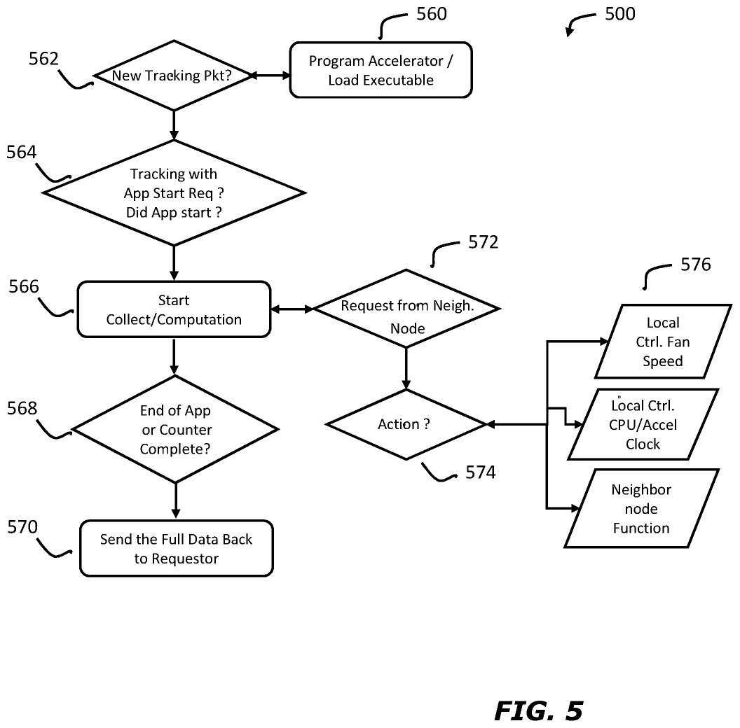

Referring to FIG. 5, a flowchart for BMC processing 500 is depicted. The BMC will start waiting for the new request packet from scheduler as illustrated by operation 562. The scheduler might also provide a corresponding acceleration function/executable, e.g., in the case where a custom accelerator data path is used. When using an external accelerator chip, such as a programmed FPGA, the accelerator is programmed with a different executable or bit stream to meet the demand of new operations that are received by the BMC. This step is illustrated by operation 560.

When new request is available, a computation bitstream and executable are loaded. If the request contains a time-based counter approach to collect sensor data, the BMC will collect the data from sensors directly or through an accelerator in local memory. If the request comes with a tag, e.g., to wait for the application start and end time, the BMC will wait for a message from the resource. The message could be, as an example, a shim message from a PCIE or MMBI interface. The instruction collection is illustrated by operation 564.

After the application start pointer is available, the BMC will track the sensor data as shown in operation 566. If the request came with a potential action to be taken, BMC will either control local node settings (e.g., fan speed, CPU frequency, etc.) or remote node settings (e.g., fan speed, CPU frequency, etc.). In the illustrated example, the BMC requests action from a neighboring node (operation 572), which can then perform the action (operation 574). As illustrated by operation 576, the action could be controlling the local fan speed, controlling the CPU and accelerator clock, or performing other neighbor node functions. Again, these specific tasks are only examples.

Once the sensor collection counter timer expires or an application end pointer is received from the shim (operation 568), the BMC sends required sensor data and details of actions taken to the scheduler as shown by operation 570.

The implementations discussed above utilize additional or modified hardware. The concepts disclosed herein, however, can also be implemented with no hardware changes. The following will provide a discussion of a software-based implementation.

The high-level software-based flow disclosed here can be used for managing application deployments across the infrastructure. Current platform management strategies act as a base to manage applications, including scheduling and autoscaling. The current monitoring and action flows include software components (e.g., scheduler, autoscaler) that are deployed on the infrastructure and manage the applications on servers in the data center. This arrangement limits the feasibility of actions that build on fine-grained monitoring data and short runtimes.

For example, systems may not update fast enough for short-running tasks. Specifically, the Function-as-a-Service paradigm aims to scale functions (applications) up and down depending on workload. These applications are usually characterized by short run times (e.g., around 100 ms). Individual software components deployed in the data center may not be able to act fast enough to adapt.

One implementation provides a decentralized delegation-based approach that addresses this issue by offering fire-and-forget and delegated actions. Fire-and-forget allows computation of fine-grained monitoring data without the overhead of transferring monitoring data and distributed computation. Delegated actions enable rapid responses to system events that alter the state of applications without the overhead of traveling or waiting for the external software components. This enables management of very short-lived tasks, such as those typically run in a function-as-a-service paradigm.

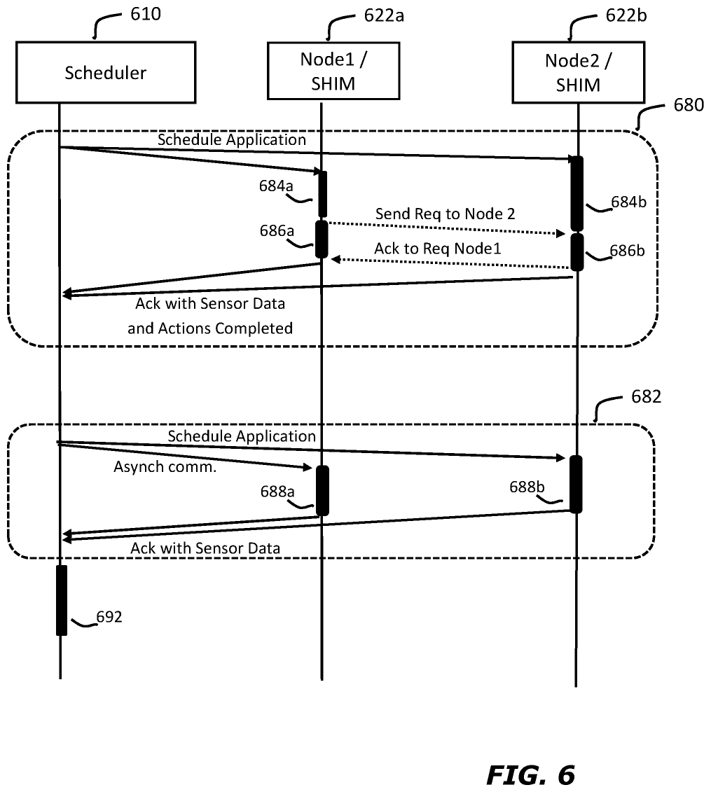

FIG. 6 provides a flowchart of a software-based scheduler flow for data center management. Two flows are shown in the diagram. The upper flow 680 leverages the shim on each node to collect the sensor data and to utilize the CPU accelerator to access the CPU and OS and perform local compute tasks to take an action to change local node settings. The action can be extended to remote node settings control. The lower flow 682 illustrates fine-grained data collection where the shim can aggregate/group data and return it to scheduler for offline-processing. These actions can be performed without the use of an internal system monitor such as Prometheus™.

Referring first to the real-time optimized scheduling 680, the scheduler 610 schedules applications with the first node/shim 622a and second node/shim 622b, respectively. For example, the scheduler may request temperature sensor tracking and computation, which be executed as illustrated by the blocks 684a and 684b. Similar to the discussion above, the nodes 622a and 622b can take action based on the tracked data as illustrated by blocks 686a and 686b. For example, the nodes might change a processor state for operating at a lower or higher frequency. These operations can be performed with limited sensor and utilization information.

For the fine-grained data collection 682, an asynchronous communication (e.g., fire-and-forget) instruction is provided from the scheduler 610 to the nodes 622a and 622b. In response, the nodes can collect CPU and accelerator information and sensor data as illustrated by operations 688a and 688b. After the given time, the instruction is acknowledged and the sensor data is provided to the scheduler.

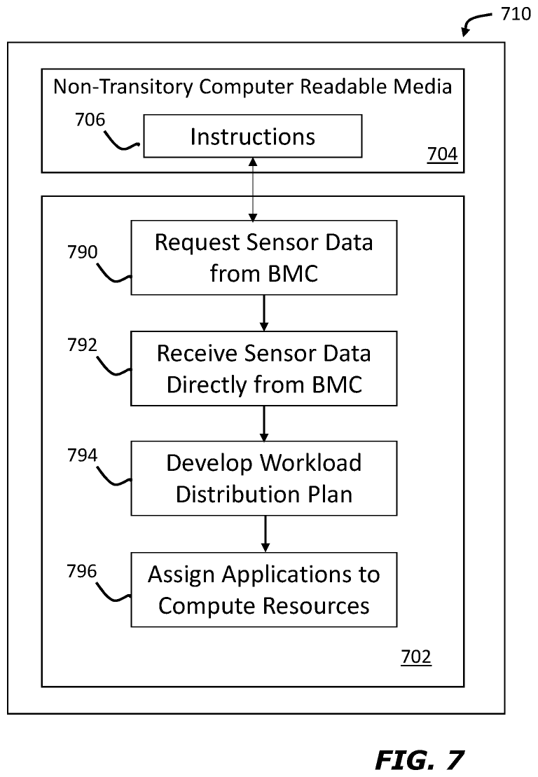

FIG. 7 illustrates an implementation example of a scheduler 710. The scheduler 710 includes a processor 702 and a non-transitory computer readable storage media 704 storing instructions 706 that, when executed by the processor 702, cause the processor to perform a computer-implemented method. Instructions are sent from scheduler 710 to a plurality of baseboard management controllers (BMCs) to obtain sensor data from a plurality of compute resources (operation 790). Each compute resource is associated with one of the BMCs. The sensor data is received directly from the BMCs (operation 792). The scheduler develops a workload distribution plan based on information related to applications waiting to be executed and the sensor data received from the BMCs (operation 794). The applications are assigned to the compute resources according to the workload distribution plan (operation 796).

As discussed above, the process may involve the scheduler dispatching a fire-and-forget command to the BMCs. In response to this command, the BMCs collect sensor data over a set time frame as outlined by the scheduler. Power levels of components within the computing units can be adjusted based on the sensor data to manage energy usage. Temperature control within the computing units may also be managed with respect to the sensor data.

As discussed herein, each BMC might send commands to its connected accelerator, prompting the collection and return of sensor data back to both the BMC and subsequently, the scheduler. Moreover, when creating a workload distribution plan, considerations regarding carbon emission intensity may be incorporated with an aim to optimize for environmental impact as well as performance.

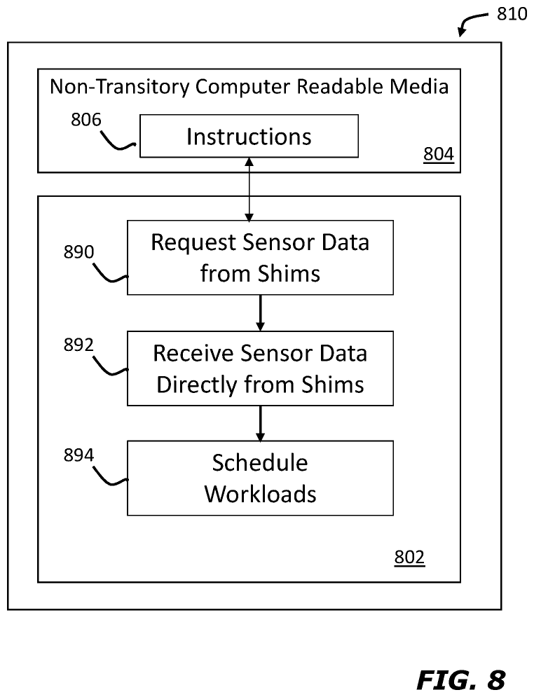

FIG. 8 illustrates another implementation example of a scheduler 810. The scheduler 810 includes a processor 802 and a non-transitory computer readable storage media 804 storing instructions 806 that, when executed by the processor 802, cause the processor to perform a computer-implemented method. Sensor information is requested from a plurality of shims (operation 890). Each shim is associated with a compute resource. The sensor information is received at scheduler 810 directly from the shims (operation 892). The sensor information provides information related to operating conditions of each of the compute resources. The scheduler 810 schedules workloads for the compute resources based on the information related to the operating conditions (operation 894).

As discussed herein, the sensor information can be requested by issuing an asynchronous communication (e.g., a fire-and-forget command) from the scheduler to the shims. The shims can aggregate the sensor information so that the sensor information received at the scheduler is aggregated sensor information. Additionally, operational parameters of the compute resources can be set by the scheduler when scheduling the workloads, the operational parameters being determined by the scheduler based on the sensor information.

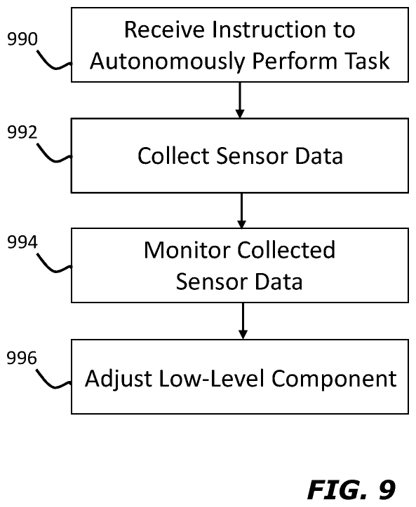

FIG. 9 illustrates a method that can be implemented by a BMC. The BMC receives an instruction, e.g., a fire-and-forget instruction, sent directly from a scheduler (operation 990). The BMC is associated with a compute resource such as a storage or compute node. The instruction indicates a task to be autonomously performed by the BMC in response to a given condition. Sensor data is collected from sensors within the compute resource (operation 992). The collected sensor data is monitored to determine whether the given condition has been met (operation 994) and, in response determining that the given condition has been met, a low-level component of the compute resource is adjusted in accordance with the instruction received from the scheduler (operation 996).

In an example implementation, the sensor data is collected by sending instructions from the BMC to an accelerator and receiving the collected sensor data from the accelerator. The BMC and the accelerator can be separate devices or can be integrated into a common integrated circuit.

The method can be used in a variety of contexts. For example, the sensor data can be temperature data so that the low-level component are adjusted to affect the temperature of the compute resource. In this case, the low-level component might be a cooling device such as a fan or a processor, e.g., a CPU or GPU.

The foregoing outlines features of several examples so that those skilled in the art may better understand the aspects of the present disclosure. Various modifications and combinations of the illustrative examples, as well as other examples, will be apparent to persons skilled in the art upon reference to the description. It is therefore intended that the appended claims encompass any such modifications.

What is claimed is:

1. A computer-implemented method comprising:
sending instructions from a scheduler directly to a plurality of compute resources to obtain sensor data from the plurality of compute resources;
receiving the sensor data directly from the compute resources;
developing, at the scheduler, a workload distribution plan based on information related to applications waiting to be executed and the sensor data received from the compute resources; and
assigning the applications to the compute resources according to the workload distribution plan.

2. The method of claim 1, wherein sending instructions from the scheduler directly to the plurality of compute resources comprises sending the instructions to a plurality of baseboard management controllers (BMCs), each BMC being associated with one of the compute resources.

3. The method of claim 2, further comprising:
sending instructions from each BMC to an associated accelerator;
collecting sensor data by each accelerator in response to the instructions;
sending the collected sensor data from each accelerator to the associated BMC; and
sending the sensor data from the BMCs to the scheduler.

4. The method of claim 1, wherein sending instructions from the scheduler directly to the plurality of compute resources comprises sending the instructions to a plurality of shims, each shim being associated with one of the compute resources.

5. The method of claim 4, further comprising aggregating the sensor data by the shims, wherein receiving the sensor data comprises receiving aggregated sensor data.

6. The method of claim 1, wherein sending the instructions from the scheduler comprises sending a fire-and-forget instruction.

7. The method of claim 1, further comprising controlling thermal management of the compute resources based on the sensor data.

8. The method of claim 1, wherein developing the workload distribution plan comprises developing a plan based on carbon emission intensity considerations.

9. The method of claim 1, further comprising setting operational parameters of the compute resources by the scheduler when developing the workload distribution plan, the operational parameters being determined by the scheduler based on the sensor data.

10. A computer system comprising:
a scheduler;
a plurality of compute resources, each compute resource functionally coupled to the scheduler;
a plurality of sensors, wherein each sensor is associated with a respective one of the compute resources;
accelerator circuitry coupled to each of the sensors; and
baseboard management controller (BMC) circuitry coupled between the scheduler and the sensors, wherein the computer system is configured so that the BMC circuitry provides sensor data from the accelerator circuitry directly to the scheduler and the scheduler distributes workloads across the compute resources based in part on the sensor data received from the BMC circuitry.

11. The computer system of claim 10, wherein each of the compute resources includes a high level component that is controlled by the scheduler and a low level component that is controlled by the BMC circuitry.

12. The computer system of claim 10, wherein each compute resource is associated with more than one sensor, the sensors being configured to measure temperature and power.

13. The computer system of claim 10, wherein, for each compute resource, the BMC circuitry and the accelerator circuitry are implemented in a single integrated circuit.

14. The computer system of claim 10, wherein, for each compute resource, the BMC circuitry is implemented in a BMC chip mounted on a motherboard of the compute resource and the accelerator circuitry is implemented by a field programmable gate array (FPGA), a complex programmable logic device (CPLD), or an application-specific integrated circuit (ASIC) mounted on the motherboard of the compute resource.

15. A method comprising:
receiving, at a baseboard management controller (BMC), an instruction sent directly from a scheduler, the BMC being associated with a compute resource, wherein the instruction indicates a task to be autonomously performed by the BMC in response to a given condition;
collecting sensor data from sensors within the compute resource;
monitoring, by the BMC, the collected sensor data to determine that the given condition has been met; and
in response determining that the given condition has been met, adjusting, by the BMC, a low-level component of the compute resource, the adjusting being in accordance with the instruction received from the scheduler.

16. The method of claim 15, wherein collecting the sensor data comprises sending instructions from the BMC to an accelerator and receiving the collected sensor data from the accelerator.

17. The method of claim 16, wherein the BMC and the accelerator are integrated into a common integrated circuit.

18. The method of claim 15, wherein receiving the instruction from the scheduler comprises receiving a fire-and-forget instruction.

19. The method of claim 15, wherein the sensor data comprise temperature data and wherein adjusting the low-level component comprises adjusting a component to affect a temperature of the compute resource.

20. The method of claim 19, wherein the low-level component comprises a cooling device or a processor.
